(19) United States
(12) Patent Application Publication
(10) Pub. No.: US 2016/0320194 A1
(43) Pub. Date: Nov. 3, 2016

(54) RIDE-SHARING USER PATH DISTURBANCES AND USER RE-ROUTING

(71) Applicant: Ford Global Technologies, LLC, Dearborn, MI (US)

(72) Inventors: Yimin Liu, Ann Arbor, MI (US); Perry Robinson MacNeille, Lathrup Village, MI (US); Jinjing Yang, Ypsilanti, MI (US)

(21) Appl. No.: 14/699,217

(22) Filed: Apr. 29, 2015

(51) Int. Cl. G01C 21/34

(52) U.S. Cl. CPC G01C 21/3438; G01C 21/3423

(57) ABSTRACT

A ride-sharing server may receive an indication of a disturbance of one or more paths within a multi-modal transportation system. The server may also identify a ride-sharing user as scheduled to travel, using a rented vehicle, along the one or more paths indicated as being disturbed; determine an alternate route for the ride-sharing user; and send an update to a mobile device of the ride-sharing user indicating the alternate route. A mobile device of a ride-sharing user may receive, from the ride-sharing server, the alternate route, and send, to the ride-sharing server, an acceptance or cancellation of the alternate route. A rental server may be informed of the change in status of the rented vehicle.

### TECHNICAL FIELD

Aspects of the disclosure generally relate to a multi-modal transportation system allowing for trip planning, bidding, displaying, and trip reservation, including identification of path disturbances and alternate routing for users based on the identification.

### BACKGROUND

A multi-modal transportation system is a system in which goods or passengers may be transported using multiple modes of transportation. These modes of transportation may include, as some examples, buses, trains, airplanes, cars, bicycles, boats (e.g., ferries, cruise lines, etc.) and even walking, and may include travel over paths such as roads, rails, monorails, tunnels, water, and air. Multi-modal transportation systems may foster competition between transportation modes such as between mass transit, multi-individual transit, and individual transit. Which transportation mode becomes dominant may depend on cultural, financial, geographic, occupant, and resource constraints. Many urban areas include multi-modal transportation systems including a hybrid of mass and individual transit systems interconnected at transportation hubs.

### SUMMARY

In a first illustrative embodiment, a system includes a ride-sharing server configured to receive an indication of a path disturbance within a multi-modal transportation system; identify a ride-sharing user scheduled to travel along the path having the disturbance before using a rented vehicle; determine an alternate route for the ride-sharing user; and send an update to a mobile device of the ride-sharing user indicating the alternate route.

In a second illustrative embodiment, a computer-implemented method includes receiving, from a ride-sharing server by a mobile device of a ride-sharing user, an alternate route for the user identified based on a path disturbance along a planned travel path of the user within a multi-modal transportation system affecting scheduling of a rented vehicle; and informing a rental server of a change in status of the rented vehicle in response to acceptance of the alternate route.

In a third illustrative embodiment, a system includes a mobile device of a ride-sharing user configured to receive, from a ride-sharing server, an alternate route identified based on a disturbance of one or more paths within a multi-modal transportation system along which the user is scheduled to travel before using a rented vehicle; send, to the ride-sharing server, an acceptance of the alternate route; and inform a rental server of a change in status of the rented vehicle.

### BRIEF DESCRIPTION OF THE DRAWINGS

FIG. 1 illustrates an example diagram including a vehicle configured to access telematics servers and a mobile device having a trip-planning application;

FIG. 2A illustrates an example logical diagram of a multi-modal transportation system;

FIG. 2B illustrates an example network diagram of the multi-modal transportation system;

FIG. 3 illustrates an example data diagram of characteristics useful for the generation of a route;

FIG. 4 illustrates an example data flow for constructing a route;

FIG. 5 illustrates an example user interface of the trip-planning application for selection of route-update options based on a revised route update;

FIG. 6 illustrates an example process for constructing a route; and

FIG. 7 illustrates an example process for automatically updating a route based on an identified stop or delay of service in the multi-modal transportation system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A multi-modal transportation system may be a system in which goods or passengers may be transported using multiple modes of transportation, such as on foot, bicycles, motorcycles, cars, buses, aircraft, watercraft and railroad trains, that are owned or leased by the traveler, or part of an ownership group the partner belongs to or are available for rent or hire. The multi-modal transportation system may include strings of multi-modal hubs connected, for example, by a rail-based mass transit system or a bus-based rapid transit system. The hubs may include features such as parking lots and rental lots, with the rental lot including storage for vehicles such as cars, motorcycles and bicycles. Around each hub may be roads, bicycle lanes and walkways so commuters may travel between hubs or to and from hubs and destinations using bicycles, rental cars or walking. In many cases, at least some of the modes of transportation operate on paths dedicated to that mode of transportation.

A ride-sharing system may include a trip-planning application installed to user's mobile devices. When the user's mobile device is within wireless transmission range of a vehicle, the trip-planning application may be configured to connect to and integrate with an in-vehicle computing platform of the vehicle. The trip-planning application may be configured to perform route optimization in accordance with information received from the connected vehicle, such as global positioning information. The trip-planning application may be configured to facilitate ride-sharing decision-making by taking into account the status of vehicle routes across the modes of transportation, and differences among costs, time, and other factors, such as the riders' characteristics, route policy (e.g., carpool lane, parking, speed limits, vehicle weight and size), and the number of vehicle occupants. Ride-sharing drivers using the trip-planning application may accordingly understand trade-offs among those factors, and make selections based on the recommendations (e.g., using the human-machine interface (HMI) of the vehicle, using the HMI of the user's mobile device, etc.). When out-of-range of a vehicle, the trip-planning application may be configured to operate autonomously, without integration with the vehicle HMI.

In some cases, the ride-sharing system may receive information indicating that a mass transit vehicle (e.g., a train, bus, plane, etc.) is running behind schedule. Therefore, as a rider may arrive to a hub later than originally intended, a start time for a route from that hub may require adjustment, invalidating some or all of a previously-planned route for the user from the hub. For example, a route as previously determined may have intended for the user to ride a train that leaves at a particular time, and the new arrival time of the user would cause the user to miss the train. As another example, a route as previously determined may still be valid, but may no longer allow for the user to reach the trip destination location in time. As an even further example, a route as previously determined may have counted on including a second rider to offset costs of renting a vehicle, and that secondary rider may be unavailable to ride-share if the driving user is late. The trip-planning application may be configured to notify users of such conditions, as well as to allow the users to approve alternate routes to address the conditions. Further aspects of the multi-modal transportation system and trip-planning application are discussed in detail herein.

This application is related to commonly-assigned applications Ser. No. ______/Attorney Docket No. 83519006, filed concurrently herewith and titled “RIDE-SHARING RANGE CONTOURS”; Ser. No. ______/Attorney Docket No. 83519020, filed concurrently herewith and titled “RIDE-SHARING ROUTING USING CONTEXTUAL CONSTRAINTS”; Ser. No. ______/Attorney Docket No. 83519032, filed concurrently herewith and titled “RIDE-SHARING LONG-TERM RIDE-SHARE GROUPS”; Ser. No. ______/Attorney Docket No. 83519041, filed concurrently herewith and titled “RIDE-SHARING JOINT-RENTAL GROUPS”, each of which is incorporated in its entirety herein by reference.

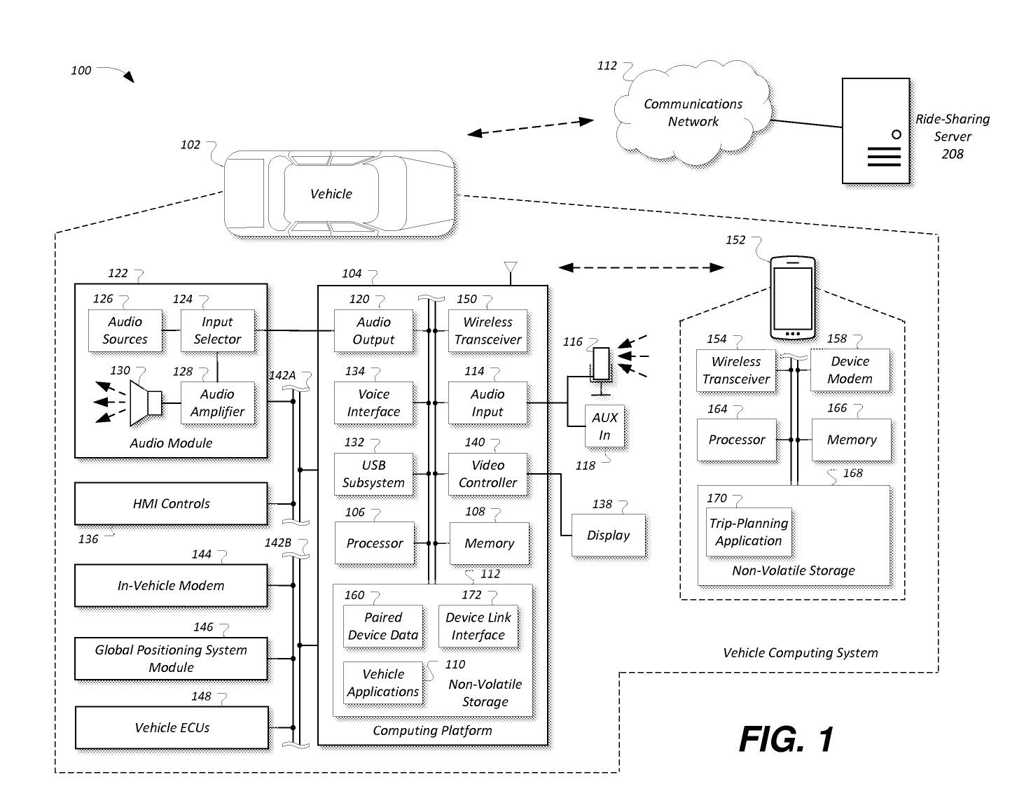

FIG. 1 illustrates an example system 100 including a vehicle 102 configured to access telematics servers and a mobile device 152 having a trip-planning application 170. The vehicle 102 may include various types of passenger vehicles, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the vehicle 102 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. An example spoken dialog system is described in U.S. Pat. No. 8,400,332, which is incorporated in its entirety by reference herein. The voice interface 134 may support speech recognition from audio received via the microphone 116 according to grammar associated with available commands, and voice prompt generation for output via the audio module 122. Different decoding speech strategies may be used, such as, phonetic, isolated word, word spotting, phrase recognition, large vocabulary continuous speech (LVCSR), etc. In some examples, different grammar languages and speech recognition engines may be utilized for the different strategies. The voice interface 134 may utilize probabilistic voice recognition techniques using the grammar in comparison to the input speech. In many cases, the voice interface 134 may include a standard user profile tuning for use by the voice recognition functions to allow the voice recognition to be tuned to provide good results on average, resulting in positive experiences for the maximum number of initial users. In some cases, the system may be configured to temporarily mute or otherwise override the audio source specified by the input selector 124 when an audio prompt is ready for presentation by the computing platform 104 and another audio source 126 is selected for playback.

In some examples, a push-to-talk button may be configured to cause voice interface 134 to begin speech recognition. In another example, an “Open Mic” feature may be implemented where the user simply begins to speak without pressing a button. This may be implemented with a voice operated switch (VOX) or with an advanced LVCSR engine that activates for a predetermined set of phrases or words (e.g., a name of the system followed by please, followed by one of a specific set of verbs). The voice interface 134 may also support barge-in, whereby the speech synthesizer begins to provide a prompt before the user has finished the sentence (which is typical of natural speech where a listener begins to speak as soon as they understand the sentence, but before it is completed). Barge-in may also allow a dialog system to intentionally initiate a dialog during moments of silence, or to interrupt and ongoing conversation. This may be used as a tactic for conveying urgency, thus getting the user's attention.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to incorporate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142-A, and the vehicle modem 144, GPS module 146, and vehicle ECUs 148 may communicate with the computing platform 104 over a second in-vehicle network 142-B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, wearable devices, E-textiles or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132. In some examples the mobile device 152 may be battery powered, while in other cases the mobile device 152 may receive at least a portion of its power from the vehicle 102 via the wired connection.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention.

When a mobile device 152 that supports network connectivity is paired with the computing platform 104, the mobile device 152 may allow the computing platform 104 to use the network connectivity of the device modem 158 to communicate over the communications network 156 with the remote telematics server 162 or other remote computing device. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications loaded to a memory 166 of the mobile device 152 from storage medium 168 of the mobile device 152. In some examples, the mobile applications may be configured to communicate with the computing platform 104 via the wireless transceiver 154 and with the remote telematics server 162 or other network services via the device modem 158. The computing platform 104 may also include a device link interface 172 to facilitate the integration of functionality of the mobile applications into the grammar of commands available via the voice interface 134. The device link interface 172 may also provide the mobile applications with access to vehicle information available to the computing platform 104 via the in-vehicle networks 142. An example of a device link interface 172 may be the SYNC APPLINK component of the SYNC system provided by The Ford Motor Company of Dearborn, Mich.

A trip-planning application 170 may be an example of an application installed to the mobile device 152 and configured to utilize the device link interface 172 to interact with the computing platform 104. When connected to the vehicle 102, the trip-planning application 170 may be configured to utilize information from vehicle sensors, actuators and electronic control units made available via the vehicle bus 142. The trip-planning application 170 may also be configured to operate when untethered from the vehicle 102, such as when the user is riding public transportation or walking. The trip-planning application 170 may be further configured to communicate with servers via the communications network 156, as discussed in detail below. The user may interact with the trip-planning application 170 through the HMI of the mobile device 152, via a web interface, or via the HMI of the vehicle 102, to avoid distraction while driving. The trip-planning application 170 may also identify where the next vehicle 102 is location for a rider's next leg of a trip, if the rider has divided a trip with several ride-sharing vehicles 102.

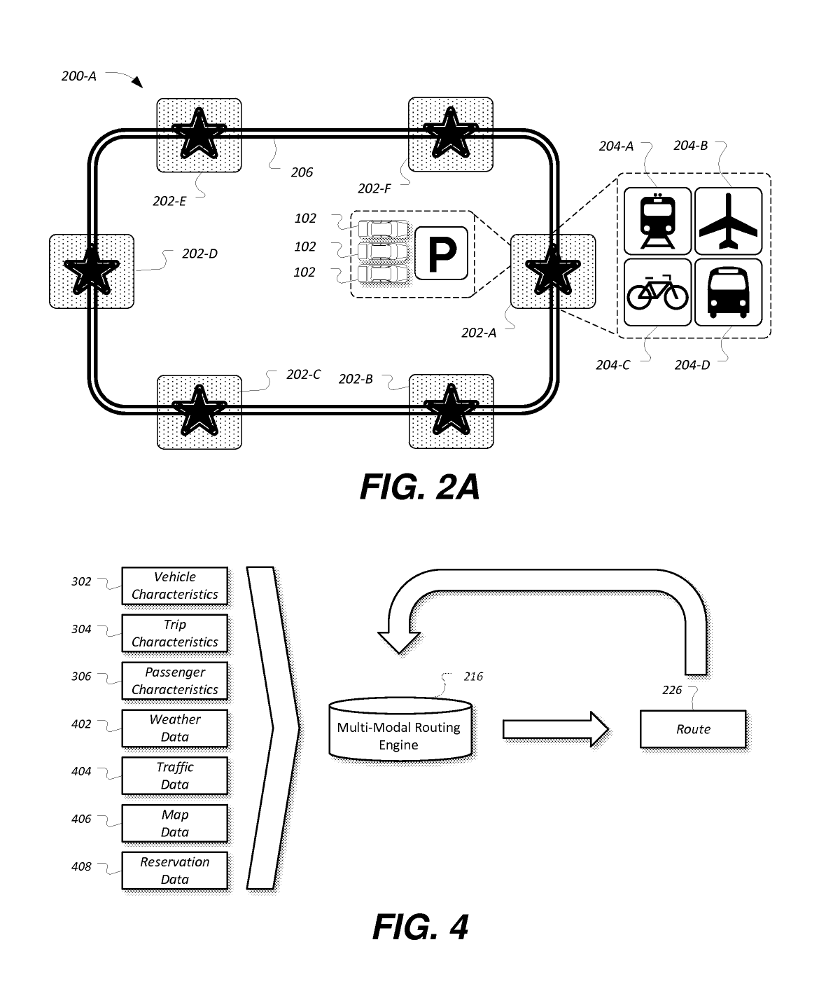

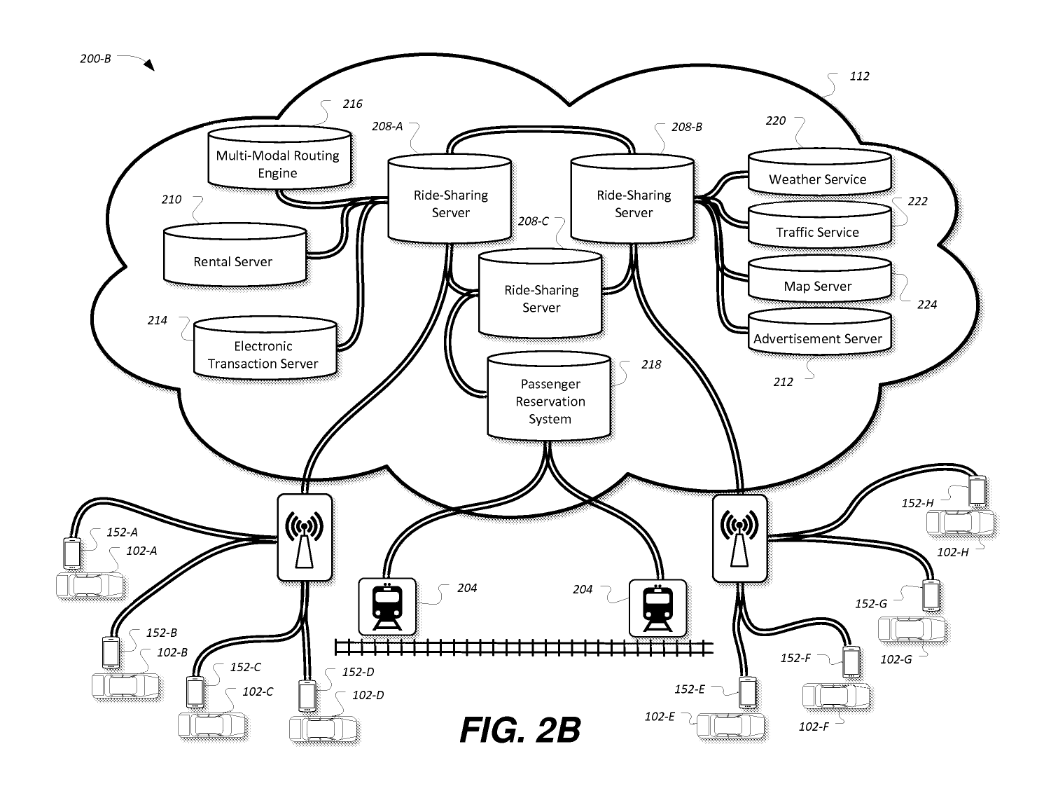

FIG. 2A illustrates an example logical diagram of a multi-modal transportation system 200. As shown, the multi-modal transportation system 200 may include multi-modal hubs 202-A through 202-F (collectively 202). The multi-modal hubs 202 may be connected by mass transportation systems 204, such as one or more of a rail-based mass transportation system (e.g., trains 204-A), an air-based mass transportation system (e.g., airplanes 204-B), a road-based transportation system (e.g., bicycles 204-C, buses 204-D, etc.), and a water-based transportation system (not pictured). The system 200 may include vehicles 102 such as cars, trucks, bicycles, train cars, or other transportation vehicles or devices, which may traverse paths 206 to facilitate the movement of users from location to location.

The hubs 202 may be configured to make the transportation systems 204 available to users of the system 200. The transportation systems 204 may include, as some possibilities, ride-sharing services, vehicle rental services, and bike rental services. These services may include a car sharing service such as the Zipcar subsidiary of Avis Budget Group of Cambridge, Mass., a bicycle sharing service such as the Hubway bicycle sharing system of Boston, Mass., a taxi service, or another service in which the vehicles 102 may rented or hired temporarily (e.g., using the mobile device 152) or utilized for a specific purpose or trip (e.g., a one-way trip). It should also be noted that in some cases the users may utilize their own vehicles 102. The hubs 202 may be configured to store vehicles 102 of the transportations systems 204, such as rented or hired vehicles 102 awaiting a rider. The hubs 202 may be configured to store vehicles 102 of individuals, typically by lease or ownership. In an example, the hubs 202 may include a parking lot or other storage for individual-owned transit vehicles 102 (e.g., cars, trucks, bicycles, etc.) and a rental lot or other storage for storage of rental transit vehicles 102 (e.g., cars, motorcycles, bicycles, etc.). The hubs 202 additionally or alternately may include one or more of storage for aircraft, trains, etc. that are often not individually owned or leased, but are owned or leased by a firm or public authority.

The hubs 202 may further be located within proximity to one or more routable paths 206 (such as roads, bicycle lanes and walkways), such that users may traverse the paths 206 to travel between hubs 202 or between hubs 202 and other destinations using the vehicles 102 or walking. In some cases, the paths 206 may be shared across modes of transportation (e.g., personal vehicles 102 and taxi vehicles 102) or across several ride-sharing vehicles, while in other cases, the paths 206 may differ according to transportation mode (e.g., trains and buses traverse different paths 206). An ordered set of paths 206 that may be traversed by a user to get from one location to another may be referred to herein as a route 226 (discussed in more detail below). It should be noted that terminology may varies between surface, nautical and aeronautical navigation. For instance, automobile routing systems may refer to an origin, a set of maneuvers, and a destination. There may further be waypoints connected by legs between each maneuver. A maneuver may be an intersection and waypoints between maneuvers describe the shape of the roads. Selection of a route may be done sequentially, e.g., by eliminating the least acceptable routes and introducing additional selective criteria and removing more unacceptable routes until one route is selected. However, unexpected or unlikely events may occur and a previously unacceptable route becomes preferred. With dynamic routing the route selection may change while underway.

FIG. 2B illustrates an example network diagram 200-B of the multi-modal transportation system 200. As shown, the communications network 156 may support communication between various components, such as mobile devices 152 of the users (whether in riding in vehicles 102 or not), ride-sharing servers 208-A, 208-B, 208-C (collectively 208), a rental server 210, an advertisement server 212, a transaction server 214, a multi-modal routing engine 216, a passenger reservation system 218, a weather service 220, a traffic service 222, and a map server 224. The system 200 may take many different forms and includes multiple and/or alternate components and facilities. While an exemplary system 200 is shown in FIG. 2B, the exemplary components illustrated of the system 200 are not intended to be limiting. Indeed, additional or alternative components and/or implementations may be used. As one example, some or all of the functionality of the multi-modal routing engine 216 may be integrated into the ride-sharing server 208.

The ride-sharing servers 208 may be configured to manage the vehicles 102 of the system 200. As shown, the multi-modal transportation system 200 includes a plurality of vehicles 102-A through 102-H (collectively 102) configured to communicate with the ride-sharing servers 208 (e.g., with or without use of the mobile device 152). The ride-sharing servers 208 may be configured to serve as points of contact for the users of the trip-planning application 170 to interact with the services of the multi-modal transportation system 200. These services may include, as some possibilities, dynamic intermediate transportation mode options, planning of trips for ride-sharing passengers and drivers (e.g., instant ridesharing, dynamic ridesharing, ad-hoc ridesharing, dynamic carpooling, etc.), and vehicle 102 position tracking. The ride-sharing servers 208 may be accordingly provide ride-sharing services to users of the system 200, allowing them to efficiently car-pool either within a hub 202 or upon arrival at a hub 202 or book another ride-sharing vehicle and show where the next vehicle is in GPS. This may accordingly speed movement through the transportation hub 202 by automatically finding ride-share partners while traveling on the mass transportation system 204 rather than trying to do an ad-hoc ride-share in the transportation hub 202, e.g., hailing a taxi upon arrival at an airport.

The ride-sharing servers 208 may further provide services to parties other than the users of the trip-planning application 170. For instance, the ride-sharing servers 208 may provide notification to the transportation systems 204 when a particular mode of transportation is selected by a user, which allows for allocation of vehicles 102 to routes 226 for the users of the system 200. In another example, short-term rental vehicles 102 may be managed by a rental server 210. The short-term rental vehicles 102 may be booked by the users via the rental server 210 and the details of the rental (e.g., cost, days rented, etc.) may be provided to the ride-sharing servers 208 for use in facilitating ride-sharing using the rented vehicle 102. For instance, the ride-sharing servers 208 may identify rented vehicles 102 or ride-sharing vehicles 102 to users that have arrived in a hub 202 by a mass transit transportation system 204 and are in need of a vehicle 102 to ride-share in to travel between the transportation hub 202 and a final destination.

The advertisement server 212 may be configured to aggregate information from transportation systems 204 to attract users and to offer special discounts in return for inconvenience such as changing a trip time, etc. The advertisement server 212 may be further configured to provide a revenue stream to operate the system 200, although the system 200 may additionally or alternatively use a subscription model to meet operational and fixed costs.

The transaction server 214 may be configured to operate as a wallet server to provide travelers with a way to purchase tickets, rent vehicles 102, etc., from the user's mobile device 152. In an example, the transaction server 214 may be configured to manage account information for users of the system, to facilitate users making and receiving payment for sharing a vehicle 102, as well as to accumulate transactions over a billing cycle (e.g., 30 days, etc.), and provide a credit, disbursement, or bill to the user at the end of the billing cycle. Accordingly, the transaction server 214 may allow for financial aspects of the ride-sharing to be performed without cash or credit transactions being performed in the vehicles 102 or hubs 202, speeding movement through the transportation centers by avoiding stops at ticket counters, as an example.

As some other possibilities, the transaction server 214 may facilitate shared ownership of transportation assets such as vehicles 102 or seats on vehicles 102, for example, a group of users may collectively own a fleet of vehicles according to a joint ownership agreement. The transaction server 214 may accordingly provide access to the shared transportation assets as determined by the joint ownership rules. Further, the transportation assets may be available to be leased, owned and shared to other users, e.g., to provide exclusive use of a seat to an individual or group in exchange for a down payment and a recurring fee. If a non-owner uses a seat that is available but owned by other users, the non-owner may pay the group who owns it for use of the seat. As another example, an employer may buy a seat for its employees. The seat may be assigned or at large, may be assigned to a specific class. If the class is full the user may be entitled to a coupon or some remuneration. The transaction server 214 may enables these ownership models, as well as facilitating accounting of payments between the users.

The multi-modal routing engine 216 may be configured to provide routing services to the ride-sharing servers 208. As discussed in detail below, the multi-modal routing engine 216 may be configured to identify travel times and paths 206 for a specific trip, as well as to identify and update routes 226 that may be affected by traffic disturbances or other travel issues, such as a vehicle 102 accident or a water main break. In some cases, the multi-modal routing engine 216 may be integrated into one or more of the ride-sharing servers 208, while in other cases some or all of the functionality of the multi-modal routing engine 216 may be separate from and callable by the ride-sharing servers 208.

The ride-sharing servers 208 may be further configured to communicate with other networked sources of information as well. In an example, the ride-sharing servers 208 may be configured to receive information from a passenger reservation system 218 of a transportation system 204, such as ticket information and train or other scheduling information. In another example, the ride-sharing servers 208 may be configured to receive information from a weather service 220 configured to provide information indicative of historical, current and/or forecast environmental conditions. In a further example, the ride-sharing servers 208 may be configured to receive information from a traffic service 222 configured to provide information indicative of historical, current and/or forecast traffic conditions along the paths 206. In yet a further example, the ride-sharing servers 208 may be configured to receive map information, such as path 206 information and route 226 information from the map server 224.

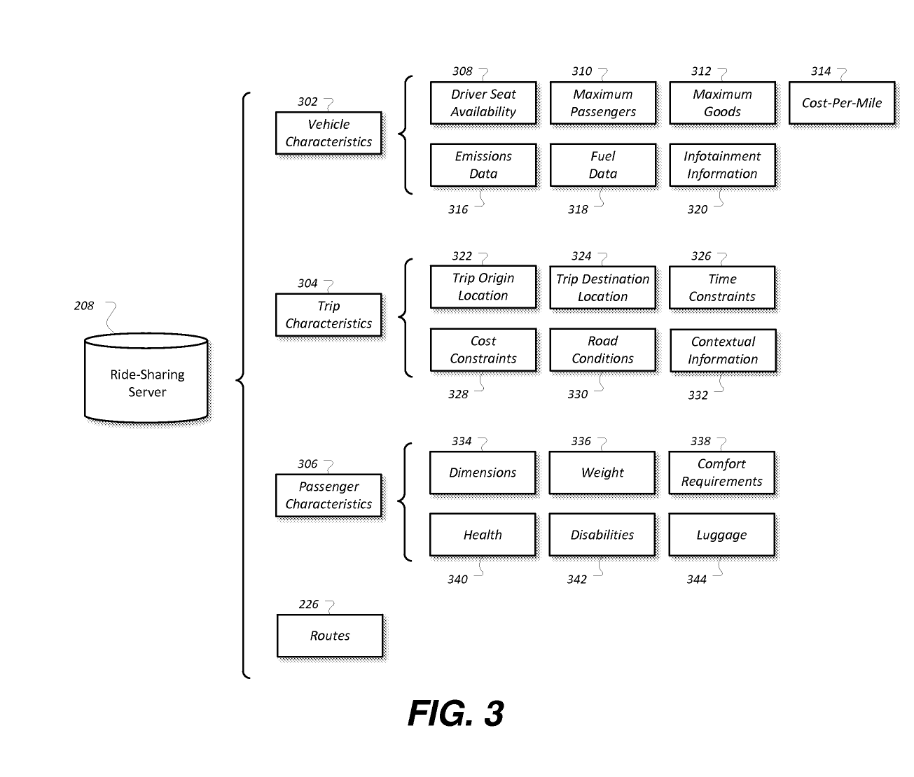

FIG. 3 illustrates an example data diagram 300 of characteristics useful for the generation of a route 226. These characteristics may include, as some non-limiting categories, vehicle characteristics 302, trip characteristics 304, and passenger characteristics 306.

The vehicle characteristics 302 may include one or more characteristics of a vehicle 102. The vehicle characteristics 302 may include information indicative of a current status of the vehicle 102, as well as information indicative of the capabilities of the vehicle 102 itself, independent of any current status. As some examples, the vehicle characteristics 302 may include a driver seat availability 308 indicative of whether or not a user is allocated to the vehicle 102 (and if so, optionally an identifier of the user), a maximum number of passengers 310 that may be simultaneously transported using the vehicle 102 (e.g., a seat belt count, etc.), a maximum amount of goods 312 that may be transported by the vehicle 102 (e.g., maximum weight, length, measure of volume, etc.), a cost-per-mile for operation 314 of the vehicle 102 (e.g., fuel efficiency information, rental cost per mile information, etc.), emissions data 316 (e.g., cleanliness of operation of the vehicle 102), fuel data 318 (e.g., a measure of liquid fuel quantity and type or battery state of charge currently available), and infotainment information 320 (e.g., whether video, calling, connectivity, or other features are available).

The trip characteristics 304 may include one or more characteristics of a user trip to be performed over the multi-modal transportation system 200. As some examples, the trip characteristics 304 may include information such as trip origin location 322 and trip destination location 324 (e.g., specified as GPS coordinates, addresses, etc.), time constraints 326 indicative of what times are desired or required for the trip to take place (e.g., a time of arrival to the destination, a time of departure based on a previous event such as arrival at a hub 202 due to a previous trip, etc.), cost constraints 328 (e.g., a maximum amount the user is willing to pay to make the trip), road conditions 330 (e.g., traffic, road closures, weather, visibility, etc.), and contextual information 332 (e.g., timing requirements such as to arrive at a movie showing).

The passenger characteristics 306 may include one or more characteristics of a passenger desiring to make a trip. The passenger characteristics 306 may include trip-specific information for the passenger, and/or characteristics of the passenger that are independent of the particular trip. As some examples, the passenger characteristics 306 include passenger dimensions 334 (e.g., height, width, etc.), passenger weight 336 (e.g., kilograms), passenger comfort requirements 338 (e.g., heating/cooling settings, massaging seat settings, etc.), heath information (e.g., whether the passenger is sick, prone to motion sickness, has special allergies such as pollen or tobacco, etc., requiring different routes or accommodations), disabilities information 342 (e.g., whether the passenger has impairments in movement or other characteristics that may affect travel), and luggage 344 (e.g., information regarding count, weight, and/or dimensions of luggage).

FIG. 4 illustrates an example data flow diagram 400 for constructing a route 226. As shown, the multi-mode routing engine 216 may receive the vehicle characteristics 302, the trip characteristics 304, the passenger characteristics 306, weather data 402 from the weather service 220, traffic data 404 from the traffic service 222, map data 406 from the map server 224, and reservation data 408 from the passenger reservation system 218. Using the received information, the multi-mode routing engine 216 may compute a route 226 including an ordered set of one or more paths 206 that may be traversed by a user.

The multi-mode routing engine 216 may be configured to identify time and cost values for various paths 206 through the multi-modal transportation system 200. In an example, the multi-mode routing engine 216 may receive map data 406 (e.g., that includes mass transit schedules, forecast arrival and departure times and actual departure and arrival times. For example, ferry schedule information may include path 206 lengths (e.g., meters) and/or path traversal cost information (e.g., estimated traffic-free travel times). The multi-mode routing engine 216 may be further configured to adjust these values in accordance with current conditions. For instance, the multi-mode routing engine 216 may utilize the weather data 402 to decrease estimated rates of travel (e.g., estimated km/hour over the paths 206 to account for account for rain, snow, ice, fog or other weather conditions. As another possibility, the multi-mode routing engine 216 may utilize the traffic data 404 to decrease estimated rates of travel over specific paths 206 identified as being slow or blocked (e.g., based on actual vehicle 102 travel time data measured from roadway loop sensors, cameras, etc.). As yet a further possibility, when a mass transportation mode is running under capacity, the multi-mode routing engine 216 may decrease costs for users traversing that system over another mode of transportation, while if the mass transportation mode is at capacity or above, the multi-mode routing engine 216 may increase costs for users traversing that system.

The multi-mode routing engine 216 may be further configured to utilize the determined path 206 values to construct one or more routes 226 from a trip origin location 322 to a trip destination location 324 that conform to the time constraints 326 and the cost constraints 328 of the trip characteristics 304. For example, the multi-mode routing engine 216 may utilize a least-cost routing algorithm to determine candidate routes 226 from the trip origin location 322 to a trip destination location 324, and then may discard those routes that do not conform to the time constraints 326, the cost constraints 328, and vehicle 102 number-of-occupants constraints (e.g., maximum number of passengers 310). In an example, the multi-mode routing engine 216 may prefer time constraints 326 over cost constraints 328 in cases where no route 226 meets both the time constraints 326 and the cost constraints 328. In another example, the multi-mode routing engine 216 may utilize information within the trip characteristics 304 or passenger characteristics 306 of the user requesting the route to determine whether to prefer time constraints 326 over cost constraints 328 or vice versa.

The identified routes 226 may accordingly be provided to the user. Moreover, the identified routes 226 may be maintained by the ride-sharing server 208 as well. When vehicles 102 are typically rented or trips are booked, users may typically not provide insight to the system 200 into the travel plans for the users across multiple modes of transportation. However, by storing the identified routes 226, the ride-sharing server 208 may be configured to perform operations in relation to the multiple modes of transportation that might be otherwise unavailable.

For instance, the multi-mode routing engine 216 may further utilize the route 226 and additionally-received information to provide updated routes 226 due to revised information. In an example, the multi-mode routing engine 216 may receive updated traffic data 404 indicating that one or more paths 206 of the route 226 have become blocked or slow. For instance, a water main break may close certain roads, which may require routes 226 constructed to traverse those paths 206 to be reformulated.

In another example, the multi-mode routing engine 216 may receive information indicating that a mass transit vehicle 102 (e.g., a train, bus, plane, etc.) is running behind schedule, e.g., from a mass transportation system 204. Therefore, as the user may arrive later than originally intended, the start time for the route 226 may require adjustment, invalidating some, or all, of the route 226. For example, a route 226 as previously determined may have intended for the user to ride a train that leaves at a particular time, and the new arrival time of the user would cause the user to miss the train. As another example, a route 226 as previously determined may still be valid, but may no longer allow for the user to reach the trip destination location 324 within the time constraints 326. As an even further example, a route 226 as previously determined may have counted on including a second rider to offset costs of renting the vehicle 102, and that secondary rider may be unavailable to ride-share if the driving user is late.

When information such as that in the above examples is received that may affect the route 226, the multi-mode routing engine 216 may be configured to re-determine the route 226, similar to as discussed above with respect to initial creation of the route 226. When the multi-mode routing engine 216 determines that the original route 226 is no longer possible, and a revised route 226 is indicated, the system 200 may be configured to inform the user of the revised route 226.

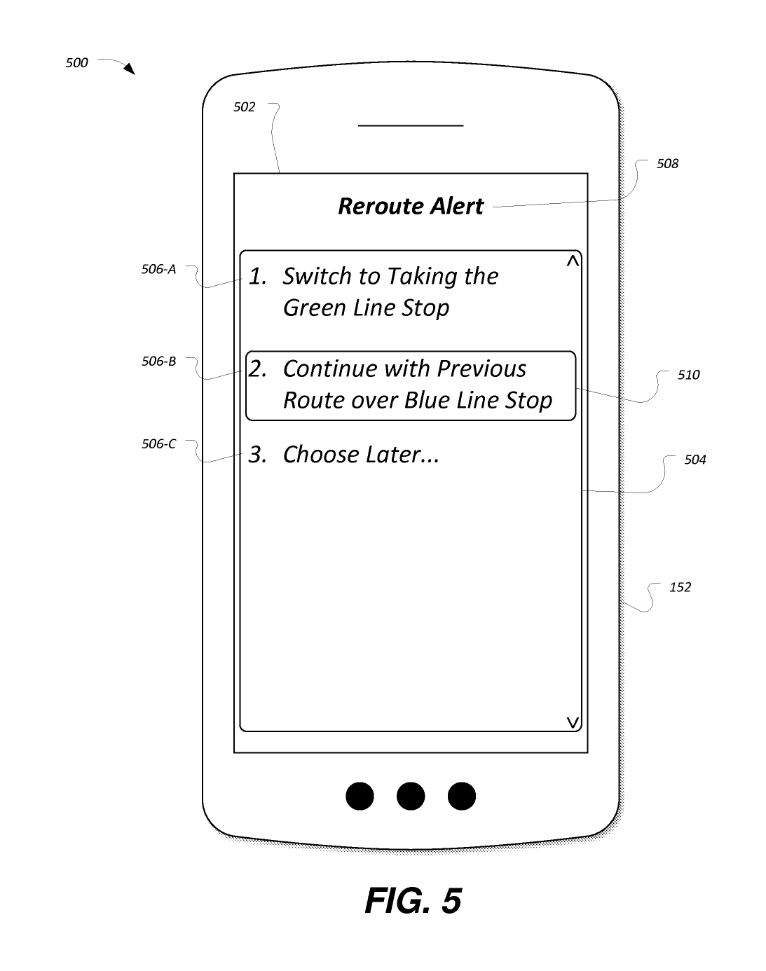

FIG. 5 illustrates an example user interface 500 of the trip-planning application 170 for selection of route-update options based on a revised route 226 update. As illustrated, the user interface 500 may be presented to the user trip-planning application 170 via a display of the mobile device 152. As another possibility, the user interface 500 may be provided to the user via a display of a paired vehicle 102.

The user interface 500 may include a list control 504 configured to display a listing of the route-update options 502 of the data criteria that may be selected by the user. As shown, each of the route-update options 502 is displayed as one of several selectable list entries 506. The user interface 500 may also include a title label 508 to indicate to the user that the user interface 500 is for selection of the route-update options 502 (e.g., altering the user that re-routing is suggested or required).

As illustrated, the list control 504 of the trip-planning application 170 includes an entry 506-A for adjusting the route 226 (e.g., to switch to taking a green line train stop instead of a blue line stop as indicated by the original route 226), an entry 506-B for continuing to utilize the original route 226 (e.g., to stop at the blue line stop), and an entry 506-C for deferring the decision on whether to update the route 226. It should be noted that the exact options, number of options, and options order is merely an example.

The list control 504 may operate as a menu, such that a user of the user interface 500 may be able to scroll through list entries of the list control 504 to adjust a currently selected list entry 510 (e.g., using up and down arrow buttons) as well as to invoke the currently selected list entry 510 (e.g., using a select button). In some cases, the list control 504 may be displayed on a touch screen display, such that the user may be able to touch the list control 504 to select and invoke a menu item. As another example, the user interface 500 may support voice command selection of the menu items. For example, to select to change to the updated route 226, the user may press a push-to-talk button or say a voice command initiation keyword, and may speak the voice command “use the updated route” or “choose route update option 1.”

Responsive to the user selection, the trip-planning application 170 may be configured to send the selection to the ride-sharing server 208. The ride-sharing server 208 may accordingly be configured to facilitate the changing of the route 226 for the user. For example, the ride-sharing server 208 may inform any users previously expecting to share a ride with a user originally scheduled to drive a vehicle 102 to rideshare, of adjusted wait time for the vehicle 102 arrival or that the ride sharing users will no longer be able to share the ride.

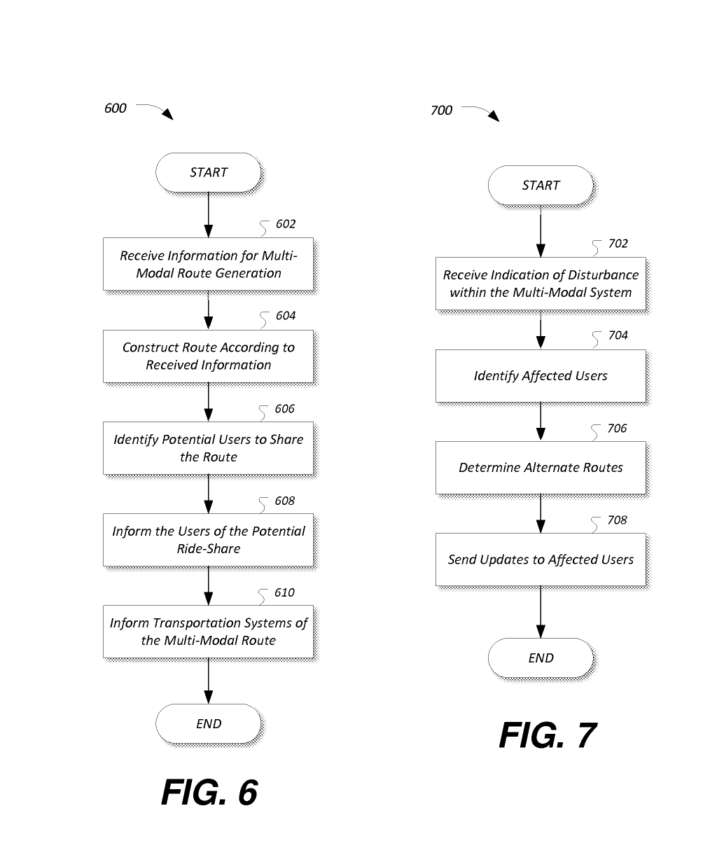

FIG. 6 illustrates an example process 600 for constructing a route 226. The process 600 may be performed, in an example, by the ride-sharing server 208 and the multi-mode routing engine 216.

At operation 602, the ride-sharing server 208 receives information for generation of a route 226 within the multi-modal transportation system 200. In an example, the ride-sharing server 208 and/or the multi-mode routing engine 216 may receive the vehicle characteristics 302, the trip characteristics 304, the passenger characteristics 306, weather data 402 from the weather service 220, traffic data 404 from the traffic service 222, map data 406 from the map server 224, and reservation data 408 from the passenger reservation system 218.

At operation 604, the ride-sharing server 208 constructs a route 226 according to the received information. In an example, the ride-sharing server 208 may utilize the multi-mode routing engine 216 to use the received information to compute a route 226 including an ordered set of one or more paths 206 that may be traversed by a user.

At operation 606, the ride-sharing server 208 identifies potential other users to share the route 226. In an example, the ride-sharing server 208 may utilize the multi-mode routing engine 216 to identify locations of other users or the locations of next ride-sharing vehicles 102 along the route 226, such as users who are within a predetermined distance from the route 226, who are a predetermined travel time from the route 226 and/or who are indicated as willing to purchase ride-sharing.

At operation 608, the ride-sharing server 208 informs the potential other users of the potential to share the route 226. In an example, the ride-sharing server 208 may send messages to mobile devices 152 of the other users to inform them of the potential ride sharing opportunity. The message indicating the potential ride sharing opportunity may further include information about the available seat, such as the location within the vehicle 102 (e.g., how many seats and what seats are available in the ride-sharing vehicles 102).

At operation 610, the ride-sharing server 208 informs the transportation systems 204 of the route 226. In an example, the ride-sharing server 208 may provide a notification to a transportation system 204 when a particular mode of transportation is selected by a user, which allows for allocation of vehicles 102 to routes 226 for the users of the system 200. The ride-sharing server 208 may also maintain the route 226, such as for use in identifying paths 206 that have become obstructed in order to generate updated route 226. After operation 610, the process 600 ends.

FIG. 7 illustrates an example process 700 for automatically updating a route 226 based on an identified stop or delay of service in the multi-modal transportation system 200. As with the process 600, the process 700 may be performed by the ride-sharing server 208.

At operation 702, the ride-sharing server 208 receives an indication of a disturbance of one or more paths 206 within the multi-modal transportation system 200. In an example, the ride-sharing server 208 may receive a notification from a passenger reservation system 218 of one of the mass transportation systems 204 indicating a delay or other change in schedule of one or more mass transit vehicles 102. In another example, the ride-sharing server 208 may receive a notification from a traffic service 222 of a traffic disturbance such as a vehicle 102 accident or a water main break. As different modes of transportation may utilize different paths 206, disturbances may affect one mode of transportation more than another mode of transportation.

At operation 704, the ride-sharing server 208 identifies any affected users. In an example, the ride-sharing server 208 may identify whether any users of the ride-sharing server 208 are scheduled to travel along any of the one or more paths 206 identified as being disturbed. This may be possible, for example, because the ride-sharing server 208 may maintain route 226 information for the users that may be otherwise unavailable when vehicles 102 are typically rented.

At operation 706, the ride-sharing server 208 determines alternate routes 226. In an example, the ride-sharing server 208 may utilize map data from the map server 224 to identify alternate routes 226 for the affected users.

At operation 708, the ride-sharing server 208 sends updates to affected riders of vehicles 102 scheduled to traverse the affected routes 226. In an example, the ride-sharing server 208 may send messages to ride-sharing users who were originally intended to ride-share with the affected users that there may be a delay. In another example, the ride-sharing server 208 may send messages to the affected ride-sharing users indicating proposed alternate routes 226. After operation 708, the process 700 ends.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a ride-sharing server configured to
receive an indication of a path disturbance within a multi-modal transportation system;
identify a ride-sharing user scheduled to travel along the path having the disturbance before using a rented vehicle;
determine an alternate route for the ride-sharing user; and
send an update to a mobile device of the ride-sharing user indicating the alternate route.

2. The system of claim 1, wherein the ride-sharing server is further configured to send an update to the mobile device of the ride-sharing user indicating number and location of available seats in the rented vehicle.

3. The system of claim 1, wherein the multi-modal transportation system further includes at least two of rail-based transportation paths, air-based transportation paths, water-based transportation paths, and road-based transportation paths, and the rented vehicle is a road-based transportation vehicle, and the path disturbance includes a disturbance of one of the rail-based transportation paths, air-based transportation paths, or water-based transportation paths.

4. The system of claim 1, wherein the ride-sharing server is further configured to:
identify, from a rental server, the ride-sharing user as a driver of the rented vehicle;
propose an alternate path for the ride-sharing user that does not use the rented vehicle; and
inform the rental server of a change in status of the rented vehicle with respect to the ride-sharing user.

5. The system of claim 1, wherein the ride-sharing server is further configured to:
identify the ride-sharing user as a ride-sharing passenger of a rented vehicle of a driver user;
propose an alternate path for the ride-sharing user that does not use the rented vehicle; and
inform the driver user of the rented vehicle of a change in status of the ride-sharing passenger with respect to the rented vehicle.

6. The system of claim 1, wherein the ride-sharing server is further configured to receive, from the mobile device of the ride-sharing user, location updates indicative of positioning of the ride-sharing user within the multi-modal transportation system, and the alternate route is based at least in part on the positioning of the ride-sharing user.

7. The system of claim 1, wherein the ride-sharing server is further configured to propose an alternate path for the ride-sharing user that includes a return trip to pick up the rented vehicle.

8. A computer-implemented method comprising:
receiving, from a ride-sharing server by a mobile device of a ride-sharing user, an alternate route for the user identified based on a path disturbance along a planned travel path of the user within a multi-modal transportation system affecting scheduling of a rented vehicle; and
informing a rental server of a change in status of the rented vehicle in response to acceptance of the alternate route.

9. The method of claim 8, wherein the multi-modal transportation system further includes at least two of rail-based transportation paths, air-based transportation paths, water-based transportation paths, and road-based transportation paths, the rented vehicle is a road-based transportation vehicle, and the path disturbance includes a disturbance of one of the rail-based transportation paths, air-based transportation paths, or water-based transportation paths.

10. The method of claim 8, wherein the scheduling of the rented vehicle includes using the rented vehicle: (i) before travel along the path disturbance or (ii) after travel along the path disturbance.

11. The method of claim 8, further comprising:
identifying, to a rental server, the ride-sharing user as a driver of the rented vehicle;
proposing an alternate path for the ride-sharing user that does not use the rented vehicle; and
informing the rental server of a change in status of the rented vehicle with respect to the ride-sharing user.

12. The method of claim 8, further comprising:
identifying the ride-sharing user as a ride-sharing passenger of the rented vehicle of a driver user;
proposing an alternate path for the ride-sharing user that does not use the rented vehicle; and
informing the driver user of the rented vehicle of a change in status of the ride-sharing passenger with respect to the rented vehicle.

13. The method of claim 8, further comprising sending, from the mobile device of the ride-sharing user to the ride-sharing server, location updates indicative of positioning of the ride-sharing user within the multi-modal transportation system, wherein the alternate route is based at least in part on the positioning of the ride-sharing user.

14. The method of claim 8, further comprising proposing an alternate path for the ride-sharing user that includes a return trip to pick up the rented vehicle.

15. A system comprising:
a mobile device of a ride-sharing user configured to
receive, from a ride-sharing server, an alternate route identified based on a disturbance of one or more paths within a multi-modal transportation system along which the user is scheduled to travel before using a rented vehicle;
send, to the ride-sharing server, an acceptance of the alternate route; and
inform a rental server of a change in status of the rented vehicle.

16. The system of claim 15, wherein the mobile device is further configured to:
identify, to a rental server, the ride-sharing user as a driver of the rented vehicle;
propose an alternate path for the ride-sharing user that does not use the rented vehicle; and
inform the rental server of a change in status of the rented vehicle with respect to the ride-sharing user.

17. The system of claim 15, wherein the mobile device is further configured to:
identify the ride-sharing user as a ride-sharing passenger of the rented vehicle of a driver user;
propose an alternate path for the ride-sharing user that does not use the rented vehicle; and
inform the driver user of the rented vehicle of a change in status of the ride-sharing passenger with respect to the rented vehicle.

18. The system of claim 15, wherein the mobile device is further configured to send, to the ride-sharing server, location updates indicative of positioning of the ride-sharing user within the multi-modal transportation system, wherein the alternate route is based at least in part on the positioning of the ride-sharing user.

19. The system of claim 15, wherein the mobile device is further configured to receive an alternate path for the ride-sharing user that includes a return trip to pick up the rented vehicle.

20. The system of claim 15, wherein the mobile device includes a smartphone executing a trip-planning application.
